(19) United States
(12) Patent Application Publication
(10) Pub. No.: US 2008/0010867 A1
(43) Pub. Date: Jan. 17, 2008

(54) Personalized footwear

(75) Inventor: Melvin Trai Davis III, Killeen, TX (US)

Correspondence Address: MOSTER WYNNE, P.C., 620 CONGRESS AVENUE, SUITE 320, AUSTIN, TX, 78701, US

(73) Assignee: Show Honor, Inc., Killeen, TX (US)

(21) Appl. No.: 11/818,828

(22) Filed: Jun. 15, 2007

Related U.S. Application Data
(60) Provisional application No. 60/806,917, filed on Jul. 10, 2006.
(60) Provisional application No. 60/805,516, filed on Jun. 22, 2006.

(51) Int. Cl. A43B 23/24; A43B 3/12; A43B 5/00; G06F 19/00

(52) U.S. Cl. 36/136; 36/106; 36/114; 700/131

(57) ABSTRACT

Footwear and methods of manufacturing footwear. One embodiment provides a personalized or customized piece of footwear including a sole, an upper member, and a customer defined decoration (e.g. a message) attached to a forward portion of the upper member. The piece of footwear may be a leather athletic shoe and the shoe supplier can control the contents of the decoration. Another embodiment provides a collection of footwear including at least two individual pieces of footwear (which may be a pair) each with a different decoration thereon. Preferably, the collection includes two hundred pairs of footwear. In another embodiment, a method of manufacturing footwear is provided. The method may include accepting at least one customer-defined decoration for the footwear and arranging for the attachment of the customer-defined decoration (by, for example, embroidery where the decoration is embroidery) onto an upper member of the footwear.

### CROSS REFERENCE TO RELATED APPLICATIONS

This non-provisional application claims priority based on co-pending U.S. patent application Ser. No. 60/806,917, filed Jun. 22, 2006, entitled HUSTLER CUSTOM SHOES and on U.S. patent application Ser. No. 60/805,516, filed Jun. 22, 2006, entitled HS SHOE INSOLES both of which are incorporated herein as if set forth in full.

### TECHNICAL FIELD

This invention relates to footwear in general and more particularly to athletically styled shoes.

### BACKGROUND

Many large shoe companies use their products to advertise their brands. More particularly, shoe vendors place their trademarks, logos, and advertisement material on their shoes in the forward area of the upper portion of the shoe. Thus, they enjoy the benefit of having their trademark displayed by their customers throughout the day and whenever else the customer might be wearing these shoes. Typically, these vendors sew pre-formed trademarks onto the uppers to accomplish these purposes.

However, consumers often wish to personalize their apparel. For instance, T-shirts represent one type of apparel that frequently receives customization after the consumer has purchased the product. Many times, the vendor of the T-shirt will offer on-the-spot silk screening to place sayings and other decorations that are pre-selected by the vendor onto the surface of the shirt. However, silk-screened decorations tend to wear quickly leaving the product with an unaesthetic appearance.

In the alternative, many vendors use a technique known as “tackle twill” in which pre-formed letters or logos may be sewn onto the T-shirt or other products. Tackle twill, therefore involves several expensive steps (selection of the letters and logos, alignment of the same with the product, sewing the letters onto the product while maintaining alignment, and then aligning the next letter with the previous one, and repeating the cycle). Furthermore, as with silk screening, tackle twill vendors pre-select the logos, or require lengthy lead times for customized logos to be created. The result in both cases leaves the consumer with a limited choice in altering the product's appearance. Thus, these types of product alterations fail to allow the consumer to freely customize, or personalize, the product.

### SUMMARY

One embodiment of the present invention provides a piece of footwear which can be personalized or customized with user-defined decorations, graphic designs, and message. More particularly, a piece of footwear of the current embodiment includes a sole, an upper member, and a user-defined decoration (e.g. a message) attached to a forward portion of the upper member. In some embodiments, the decoration can be embroidered onto the footwear. In addition, the footwear may be a leather athletic shoe and the shoe supplier can control the contents of the decoration. Other embodiments provide collections of footwear including at least two individual pieces of footwear (which may be a pair) each with a different decoration thereon. Preferably, the collection includes at least about two hundred pairs of footwear.

Another embodiment of the present invention provides shoes which are custom made for individuals with information panels on each side of the shoe. The information in the information panels can include the customer's name or any other information the customer desires. Thus, these shoes can be custom designed for the individual who desires a shoe with their name or other information on the shoe. Further, the shoe can be made with leather uppers, a rubber sole, and a shock-absorbing insole. The leather uppers of the current embodiment provide support and comfort to the wearer's ankles. In addition, the rubber sole can provide both durability and shock absorption for the wearer. Additionally, an insole can be included in the footwear to provide comfort and shock absorption.

Yet another embodiment of the present invention provides a method of manufacturing footwear. The method includes accepting at least one user-defined decoration for the footwear and arranging for the embroidering of the user-defined decoration onto a forward portion of an upper member of the footwear. Indeed, the current method may also include actually embroidering the decoration onto the footwear, receiving the embroidered footwear, and distributing it to the user. In some embodiments, the decoration for the individual pieces of footwear differ from each other even if the footwear constitutes a “pair” (e.g., a right and a left show with the same size and style) of footwear. Additionally, the current method may include accepting an order for such personalized footwear with at least two hundred pair of footwear. These orders may be accepted over a wide area network such as the Internet, from kiosks, are even by hand written orders at a store or other retail location.

In still other embodiments of the present invention, the decoration(s) may include a message, word, or phrase. If the decoration includes a message the supplier of the footwear may control, or edit, the decoration to maintain an esthetically appealing product line. In other words, the footwear provider may prevent the users from designating harmful, obscene, or obnoxious decorations for the footwear. Moreover, the footwear supplier may confirm (via e-mail for instance) the order including sending the customer the finalized version of the decoration designation(s). Yet another embodiment provides a machine readable medium which includes executable instructions stored thereon for accepting at least one user-defined decoration for a piece of footwear and for transmitting the designation of the user-defined decoration to a manufacturer for the attachment of the decoration onto an upper member of the footwear. The instructions can also allow for accepting a decoration for a left piece of footwear and accepting a decoration designation for a right piece of footwear. In addition, the instructions can provide for controlling (or editing) the decoration and for embroidering it onto the upper member of the footwear as well as for confirming the order.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a piece of footwear constructed in accordance with the principles of the present invention.

FIG. 2 is a perspective view of another piece of footwear constructed in accordance with the principles of the present invention.

FIG. 3 is a schematic view of a system constructed in accordance with the principles of the present invention.

FIG. 4 is a flow chart of a method practiced in accordance with the principles of the present invention.

### DETAILED DESCRIPTION

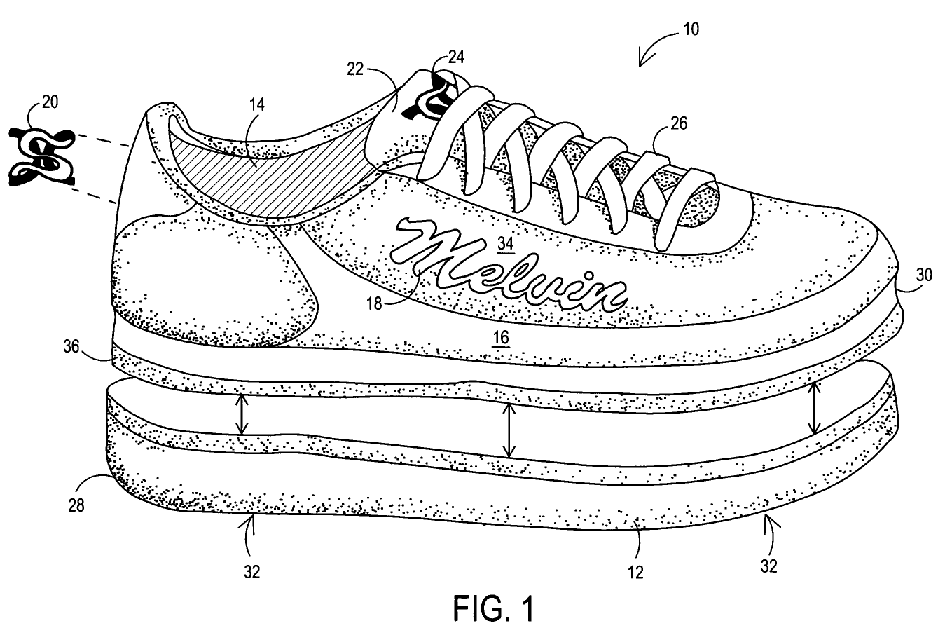

Referring to FIG. 1 of the drawings, the reference numeral 10 generally designates a piece of footwear embodying features of the present invention. The piece of footwear 10, or shoe, includes a sole 12, an opening 14 for the user's foot, an upper 16, a decoration 18, and trademark 20. Here, the trademark shown is that of Show Honor, Inc. of Killeen, Tex. which offers footwear as disclosed herein. The shoe 10 may also include a tongue 22, a second trademark 24, and laces 26. Generally, the shoe 10 also includes a heel 28, a toe 30, and a mid-foot area 32 which extends forward from near the heel 28 to near the toe 30.

When the user wears the shoe 10, the sole 12 of course lies underneath the wearer's foot and serves to protect the sole of the wearer's foot from contact with the ground and objects thereon. Thus, the sole 12 may be made from rubber or any material suitable for such purposes. The upper 16 provides further protection for the users foot and at least partially encircles or encloses the foot and is attached to the sole 12 at points along the sole's periphery. In some embodiments, the upper 16 may also extend up along the wearer's ankle to brace and stabilize the same. Additionally, some shoes 10 include the tongue 22 which facilitates the entry and removal of the wearer's foot into the opening 14. In such embodiments, the laces 26 repeatedly cross over the tongue 22 and can be tied together at their free ends to draw the upper 16 closed over the tongue 22 thereby securing the shoe 10 to the user's foot. While the shoe 10 shown by FIG. 1 is an athletic shoe, the present invention is not limited thereby. Rather, the scope of the present invention extends to all types of footwear including athletic shoes, dress shoes, sandals, high heels, and cowboy boots for example.

Furthermore, the upper 16 defines the opening 14 for the user's foot which is located near and above the heel 28. Thus, if the user wears long pants (as opposed to shorts, a skirt, swim attire, or the like) the heel area 28 may be hidden by the hem of the user's pants. However, even if the user wears long pants, the mid-foot area 32 and other sections forward of the opening 14 generally remain visible. Thus, the forward portions of the upper 16 represent one place to locate the decoration 18. Additionally, the inventor has noted that the toe area 30 tends to accumulate dirt and stains faster than the rest of the upper 16. Thus, in accordance with the principles of the present invention, the mid-foot area 32 is well suited for displaying personalized decorations 18 where they will remain both visible and clean for long periods. Additionally, decorations 18 placed on the upper 16 in the forward region will usually be visible regardless of the user's choice of clothing. More particularly, the inventor has found that the area of the upper 16 generally adjacent to the tongue 22, or laces 26, serves satisfactorily to display the decoration 18. In accordance with the principles of the present invention this area can be designated as an “information panel” 34 on which the decorations 18 can be displayed.

With regard to the decoration 18, it can be a group of letters, a short message, a name, a graphic design, or any combination thereof which can fit in the information panel 34. Some embodiments include messages 18 with up to 12-14 appropriately sized characters therein, For example, in FIG. 1, the decoration 18 includes the name “Melvin” although the user could create any textual message (or graphic symbol) for the decoration 18. In one embodiment, the decoration 18 is embroidered onto the upper 16. Other forms of attachment and types of decorations, however, are within the scope of the present invention. Embroidering the decoration 18 onto the upper provides many advantages. First, because the embroidered decoration 18 typically includes many layers of thread, it holds up well to the scuffs, kicks, and other mechanical abuse likely to occur to parts of a shoe 10. Additionally, the embroidered decoration 18 stands out from the surface of the upper 16 lending the shoe 10 an aesthetic pleasing appearance. This latter advantage can be enhanced with the selection of another fashionable material such as leather for the upper 16. Moreover, embroidery provides a relatively inexpensive, flexible, and reliable method of adding the decoration 18 to the shoe 10. More particularly, by controlling the embroidering needle with a computer, any message or graphic design can be added to the shoe 10 by providing the manufacturing computer a file defining the decoration 18. Also, because (unlike tackle twill) no parts other than the shoe 10 and the thread which forms the decoration 18 need be handled, the manufacture of the decoration 18 is relatively simple and requires no complicated jigs or alignment devices.

As mentioned previously, FIG. 1 also shows that the shoe 10 may include the trademarks 20 and 24 or other vendor imposed advertising materials. The trademark 20 is shown being attached to the heel 28 portion of the upper 16 as indicated by the dashed lines between the trademark 20 and the upper 16. Meanwhile, trademark 24 is shown toward the upper end of the tongue 22. In addition, although not shown, such trademarks 20 and 24 may be included on the upper 16 directly below the opening 14. However, conventional shoes display such trademarks in the mid-foot area 32 of the shoe. Moreover, these conventional trademarks are typically sewn onto the shoe rather than being embroidered thereon. Thus, it is impossible to add a user defined decoration 18 in the mid-foot region 32 of a conventional shoe without disfiguring the shoe.

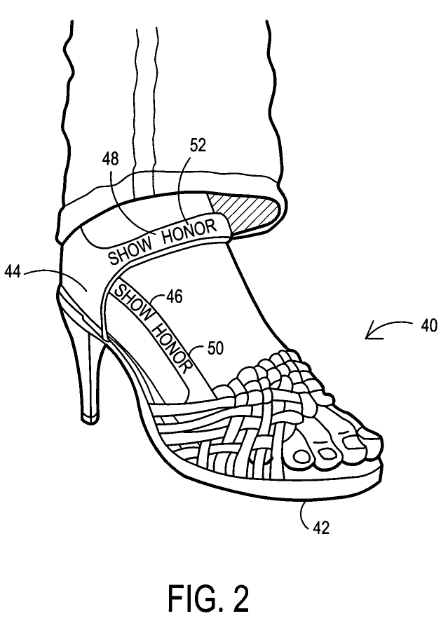

With reference now to FIG. 2, a piece of footwear 40 of another embodiment of the present invention is shown. The footwear 40 is a sandal with a sole 42 and an upper 44 which is largely composed of interlacing straps of leather or other fabric. More particularly, two of the straps of leather 46 and 48 each have an area where decorations 50 and 52 respectively can be embroidered onto the shoe 40. Furthermore, FIG. 2 shows that the straps 46 and 48 each help to partially encircle or enclose the user's foot besides holding the decorations 50 and 52. More particularly, strap 48 can include a buckle or other device (not shown) for securing the sandal 40 to the user's foot. Strap 50 was added to this particular sandal 40 to provide an additional upper portion on which to place a decoration 50. Since sandals 40 have relatively small upper members (e.g. straps 48 and 50), FIG. 2 illustrates that many types of footwear can be decorated in accordance with the principles of the present invention.

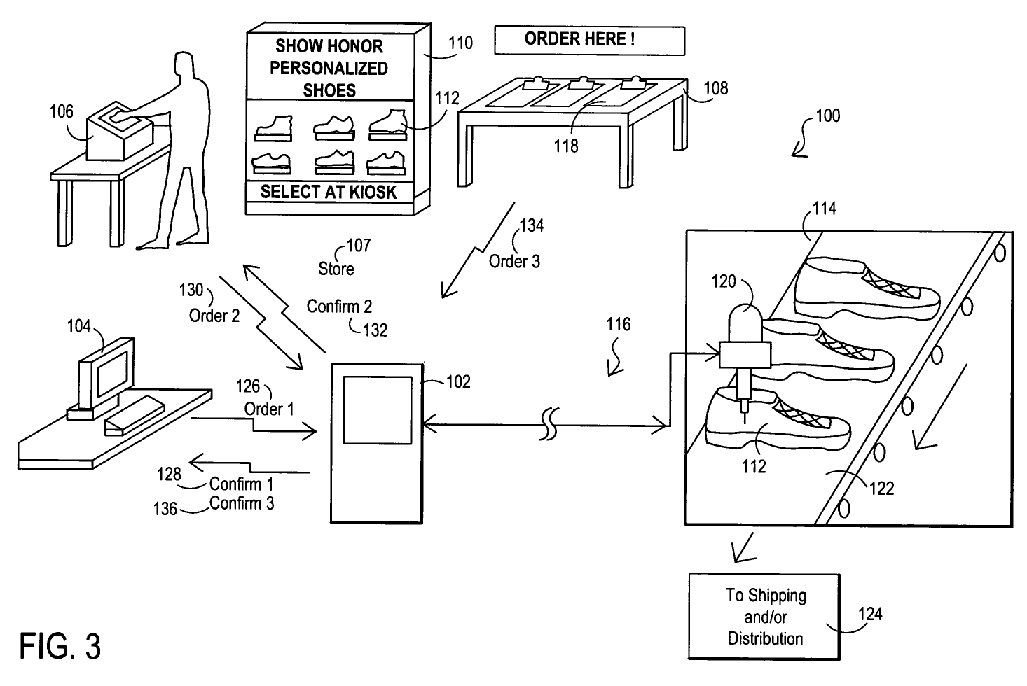

With reference now to FIG. 3, an exemplary shoe ordering and manufacturing system 100 is shown. The system 100 includes a server 102, several mechanisms 104, 106, and 108 for accepting customer orders, a display 110 of footwear 112, a manufacturing facility 114 and a network 116 to allow communication between the various other components of the system 100. Mechanism 104 is typically a personal computer located in a home or office which allows the user to place orders with, and receive order confirmations from, the server 102. Likewise, mechanism 106 may be a computerized kiosk which accomplishes similar functions as personal computer 104. The kiosk 106 of course may be located in a public location such as a store, mall, sporting venue (e.g. a stadium), or other retail location. Furthermore, display table 108 also allows orders to be placed via hard copy order forms 118 which may then be entered via order entry mechanisms 106 or 108.

In addition to taking such conventional information about the order as the identity and address of the customer, method of payment, shoe size, and shoe style (including color information), the system 100 also allows the user to specify the message and graphic design of the decoration for the order. Moreover, the system 100 also allows the user to specify different messages or graphic elements for the right shoe 112 and the left shoe 112 of any given pair of footwear. Even though the size of the order is essentially unlimited, each pair of shoes can be personalized, or tailored, according to the message and graphic design selections of the user. More particularly, the order entry mechanisms 104, 106, and 108 allow the user to enter the message (selecting fonts and text colors) and to either create a graphical design or attach a file containing the definition of the graphical design for each right and left shoe in the order if so desired. Moreover, the system 100 allows the user to designate the location on each shoe where the decoration will be placed. Of course, the system 100 may allow for a default location for the different decorations such as on the outside of the shoe (i.e., on the right side of the shoe for a right shoe and on the left side of the shoe for a left shoe). In one embodiment, the size of the order typically includes two hundred or more pairs of shoes although smaller and larger orders can be accepted. In any case, the system 100 can create a file with the order information (including the definition of the decoration) for subsequent use or storage.

No matter which mechanism 104, 106, or 108 is used to place the order, the order file or record can be communicated from the server 102 to the manufacturing facility 114 via the network 116. The network 116 may then deliver the file which defines the decoration(s) to an automated embroidering machine 120 in the manufacturing facility 114. In turn, the embroidering machine may position itself with respect to the shoe which has been selected for a given order and embroider the decoration onto the designated location of that particular shoe. A conveyor or other material handling machine 122 may then advance the completed shoe on to the shipping and distribution subsystem 124 while advancing the shoe selected for the next order (or the next part of the same order) to the embroidering machine 120. The embroidering machine 120 may then align itself with that next shoe and repeat the cycle until the system 100 completes the order(s). Of course, other manufacturing arrangements 114 can be employed to automatically select the shoes for an order and attach the decoration(s) to the appropriate shoe(s). From the manufacturing facility 114, the system 100 allows the shoes to be shipped and distributed to the users who placed the orders via conventional delivery modes such as trucks, trains, ships, and aircraft.

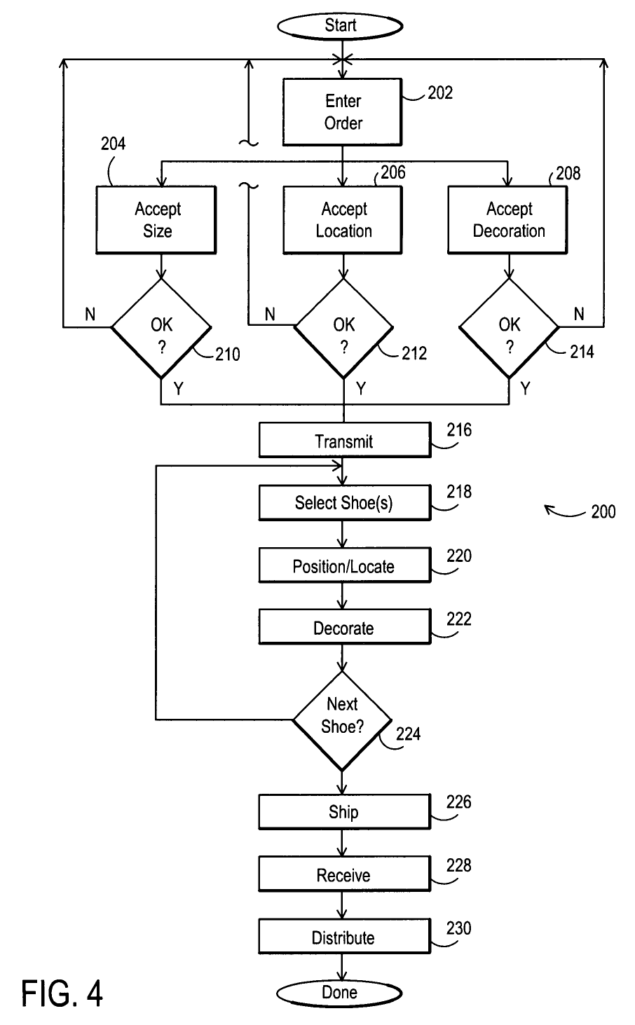

Now turning to FIG. 4, a method 200 of ordering and manufacturing footwear is illustrated. In the method shown in FIG. 4 the customer may enter an order as discussed above with reference to the system 100. See operation 202. More particularly, the customer can select from a broad range of shoes colors which include Blue, Black, Red, Yellow, and Orange among others. Similarly, the customer may chose from a broad range of thread colors from which the decoration will be created. These colors include, but are not limited to, Black, White, Silver, Yellow, and Red.

Each portion of the order can then be accepted as indicated at references 204, 206, and 208. More particularly, the order size and the designated locations can be checked to see if they are within acceptable ranges as shown by decision operations 210 and 212. One interesting feature of the current embodiment is shown by reference 214 where the system allows the footwear vendor, or some other third party, to examine the customer defined decoration and edit or reject the order if the decoration fails to meet certain standards (e.g. it's vulgar, gang related, or otherwise offensive). Thus, operation 214 allows the footwear vendor to maintain the quality of the footwear produced via method 200. If the order fails any of the checks 210, 212, and 214, the method 200 allows the user to re-enter or correct the order at operation 202.

Once the vendor decides to accept the order, the resulting file that defines the order can be transmitted to the manufacturing facility. See operation 216. At the manufacturing facility, the order can be parsed and the appropriate shoe(s) can be selected for decorating as shown at operation 218. Either the shoe or the embroidery machine or both can be aligned with each other. See reference 220. Operation 222 shows that the decoration may then be attached to the footwear at the user designated location (e.g., on the mid-foot or a forward area of the shoe upper). If the order is not finished, the method may continue with the next shoe in the order as shown at decision 224. However, if the order is finished, the footwear can be packaged and shipped. See operation 226. Of course, the footwear may be shipped directly to the customers. However, method 200 also allows the footwear to be received by, for instance, a vendor or distributor as shown at reference 228. The vendor may then distribute the footwear to the customers or perhaps retail locations for sale or pick-up. See reference 230.

In addition to the foregoing embodiments, the present invention provides programs stored on machine-readable medium to operate computers and devices according to the principles of the present invention. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine-readable media include transmission media (network transmission line, wireless transmission media, signals propagating through space, radio waves, infrared signals, etc.) and server memories. Moreover, machine readable media include many other types of memory too numerous for practical listing herein, existing and future types of media incorporating similar functionality as incorporated in the foregoing exemplary types of machine readable media, and any combinations thereof. The programs and applications stored on the machine-readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

The use of the present invention provides many advantages over the prior art including the ability to personalize pieces of footwear. Additionally, the footwear provided by the present invention allows personalized decorations to be placed in highly visible locations on the footwear so that the user may maximize the enjoyment of having such a product. Moreover, the placement (for example, on the mid-foot region of the upper of the footwear) of the decorations may be such that the decoration may stay clean longer than it would at other locations. Footwear have also been provided which give the user improved comfort than heretofore possible.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A piece of footwear comprising:
a sole member to be generally adjacent to a sole of the foot of a customer and adapted to protect the sole of the foot of the customer;
an upper member attached to the sole member in such a manner that the sole member and the upper member are adapted to at least partially enclose the foot of the customer, the upper member to be generally adjacent to the foot of the customer; and
a customer-defined decoration attached to a forward portion of the upper member.

2. The piece of footwear of claim 1 further comprising the footwear being an athletic shoe.

3. The piece of footwear of claim 1 wherein the upper member is leather.

4. The piece of footwear of claim 1 wherein the decoration includes a message.

5. The piece of footwear of claim 1 wherein the decoration is controlled by a supplier of the piece of footwear.

6. The piece of footwear of claim 1 wherein the customer-defined decoration is embroidery.

7. The piece of footwear of claim 1 wherein the customer-defined decoration is attached to the upper member by embroidery.

8. A footwear collection comprising:
a first piece of footwear including:
a first sole member to be generally adjacent to a sole of a foot of a first customer and adapted to protect the sole of the foot of the first customer,
a first upper member attached to the first sole member in such a manner that the first sole member and the first upper member are adapted to at least partially enclose the foot of the first customer, the first upper member to be generally adjacent to the foot of the first customer, and
a first customer-defined decoration attached to a forward portion of the first upper member; and
a second piece of footwear including:
a second sole member to be generally adjacent to a sole of a foot of a second customer and adapted to protect the sole of the foot of the second customer,
a second upper member attached to the second sole member in such a manner that the second sole member and the second upper member are adapted to at least partially enclose the foot of the second customer, the second upper member to be generally adjacent to the foot of the second customer, and
a second customer-defined decoration attached to a forward portion of the second upper member.

9. The collection of claim 8 wherein the first piece of footwear and the second piece of footwear are a pair.

10. The collection of claim 8 further comprising at least about two hundred pairs of footwear.

11. The collection of claim 8 wherein the first and the second decorations differ from each other.

12. The collection of claim 8 wherein the customer-defined decorations are attached to the respective upper members by embroidery, the customer-defined decorations being embroidery.

13. A method of manufacturing footwear, comprising:
accepting a definition of at least one customer-defined decoration for the footwear; and
arranging for attaching the customer-defined decoration onto a forward portion of an upper member of the footwear, the footwear including a sole member to be generally adjacent to the sole of the foot of a customer, adapted to protect the sole of the foot of the customer, and attached to the upper member, the sole member and the upper member being adapted to at least partially enclose the foot of the customer, the upper member to be generally adjacent to the foot of the customer.

14. The method of claim 13 wherein the accepting the definition of at least one customer-defined decoration includes accepting a definition of a customer-defined decoration for a left piece of footwear and accepting a definition of a customer-defined for a right piece of footwear, the right and left pieces of footwear to be a pair.

15. The method of claim 14 wherein the definitions of the right and left customer-defined decorations differ from each other.

16. The method of claim 13 further comprising accepting an order for at least about two hundred pairs of footwear.

17. The method of claim 13 wherein the accepting the definition of the customer-defined decoration occurs via a wide area network.

18. The method of claim 13 wherein the accepting the definition of the customer-defined decoration occurs via a store.

19. The method of claim 13 further comprising receiving the footwear with the customer-defined decoration embroidered thereon.

20. The method of claim 19 further comprising distributing the footwear to the customer.

21. The method of claim 13 further comprising embroidering the customer-defined decoration onto the footwear.

22. The method of claim 13 wherein the decoration includes a message.

23. The method of claim 13 further comprising controlling the definition of the customer-defined decoration.

24. The method of claim 13 further comprising confirming the definition of the customer-defined decoration.

23. A machine-readable medium comprising executable instructions stored thereon for:
accepting at least one definition of a customer-defined decoration for the footwear; and
transmitting the definition of the customer-defined decoration to a manufacturer for attaching the customer-defined decoration onto a forward portion of an upper member of the footwear, the footwear including a sole member to be generally adjacent to the sole of a foot of a customer, adapted to protect the sole of the foot of the customer, and attached to the upper member, the sole member and the upper member being adapted to at least partially enclose the foot of the customer, the upper member to be generally adjacent to the foot of the customer.

24. The machine-readable medium of claim 23 wherein the accepting the at least one definition of the customer-defined decoration includes accepting a definition of a customer-defined decoration for a left piece of footwear and accepting definition of a decoration for a right piece of footwear, the right and left pieces of footwear to be a pair.

25. The machine-readable medium of claim 23 further comprising executable instructions stored thereon for embroidering the customer-defined decoration onto the upper member of the footwear.

26. The machine-readable medium of claim 23 further comprising executable instructions stored thereon for controlling the definition of the customer-defined decoration.

27. The machine-readable medium of claim 23 further comprising executable instructions stored thereon for confirming the definition of the customer-defined decoration.

28. A piece of footwear comprising:
a sole member to be generally adjacent to a sole of the foot of a customer and adapted to protect the sole of the foot of the customer;
an upper member attached to the sole member in such a manner that the sole member and the upper member are adapted to at least partially enclose the foot of the customer, the upper member to be generally adjacent to the foot of the customer; and
a customer-defined decoration attached to the sole member.
